(19) United States
(12) Patent Application Publication
(10) Pub. No.: US 2004/0099089 A1
(43) Pub. Date: May 27, 2004

(54) Single bearing differential support for an axle

(76) Inventors: Erwin Mock, Montgomery, IL (US); Mark A. Niemeyer, Forsyth, IL (US)

Correspondence Address: CATERPILLAR INC., 100 N.E. ADAMS STREET, PATENT DEPT., PEORIA, IL, 616296490

(21) Appl. No.: 10/304,560

(22) Filed: Nov. 26, 2002

(51) Int. Cl. F16H 57/02

(52) U.S. Cl. 74/607

(57) ABSTRACT

An axle housing for a vehicle is provided. The axle housing is made up of two or more subhousings, and a differential is mounted to at least one of the subhousings. A single bearing substantially supports the weight of the differential and allows the differential to rotate within, and with respect to, the axle housing.

### TECHNICAL FIELD

This invention is of the form of an axle housing assembly and, more specifically, an axle housing assembly in which a single bearing supports the differential.

### BACKGROUND

On- and off-highway trucks, work machines such as wheel loaders, automobiles, and wheeled vehicles of many other types use an axle to transfer power from an engine or other power source to the wheels of the machine. The axle is generally at least partially located within an axle housing which mounts to the chassis of the machine and contains gears, bearings, brakes, and other axle components in addition to the axle. Large forces pass through the axle, especially in heavy equipment such as trucks and construction type machines, necessitating a strong and robust but lightweight (for fuel efficiency) axle and axle housing design.

The specific portion of the axle assembly which does most of the power transmission work is called the differential. Power from the engine generally passes through a rotating driveline, and the differential uses gears to transform the driveline rotation into wheel rotation.

The differential is commonly mounted inside an axle housing which contains support structures which allow the differential to rotate about the lateral axis within the housing in a known manner. The support structures are most often bearings, one on either end of the differential. An outer race of the bearings is attached to bearing supports within the axle housing and an inner race of the bearings is attached to the differential. The bearing supports are operative to hold the differential away from the inside surface of the axle housing and also to transmit forces from the differential to the axle housing and thereby to the chassis of the vehicle.

An example of a differential arrangement as above is shown in U.S. Pat. No. 5,286,239, issued Feb. 15, 1994 to Kenichiro Ito et al. (hereafter referenced as '239). '239 discloses a differential mounted within an axle housing as described above. However, the supporting bearings are relatively small, necessitating multiple bearings to adequately dissipate the differential forces to the axle housing. Also, each set of bearing supports requires excess material within, and additional machining of, the axle housing. Finally, as the '239 device is built, one of the bearings will have to be assembled “blind”, or in such a way that the body of the differential and the axle housing itself block the assembler's view of the bearing. This brings about additional difficulty in the positioning, shimming, and mounting process for that bearing.

The present invention is directed to overcoming one or more of the problems as set forth above.

### SUMMARY OF THE INVENTION

In a preferred embodiment of the present invention, an axle assembly is disclosed. The axle assembly includes at least two subhousings connectable to form an axle housing, a differential located inside the axle housing and attached to at least one of the subhousings, and a bearing mounting the differential to the subhousing and substantially supporting the weight of the differential.

In a preferred embodiment of the present invention, a method of assembling an axle is disclosed. The method includes the steps of providing a first subhousing, attaching an outer race of a single bearing to the first subhousing, attaching a differential to an inner race of the bearing such that the bearing is the only permanent intermediate structure between the differential and the first subhousing, surrounding the differential with a second subhousing, and attaching the second subhousing to the first subhousing.

In a preferred embodiment of the present invention, a vehicle, including a machine body, an operator compartment carried by the machine body; and a ground engaging system providing motive power to the machine body is disclosed. The ground engaging system includes at least one wheel attached to an axle. The axle includes at least two subhousings connectable to form an axle housing, a differential located inside the axle housing and attached to at least one of the subhousings, and a bearing mounting the differential to the subhousing and substantially supporting the weight of the differential.

### BRIEF DESCRIPTION OF THE DRAWINGS

FIG. 1 is a side view of a vehicle incorporating a preferred embodiment of the present invention;

FIG. 2 is a perspective view of an axle housing incorporating a preferred embodiment of the present invention;

FIG. 3 is a partial perspective cutaway view of an axle housing incorporating a preferred embodiment of the present invention; and

FIG. 4 is a perspective view of an axle housing incorporating a preferred embodiment of the present invention.

### DETAILED DESCRIPTION

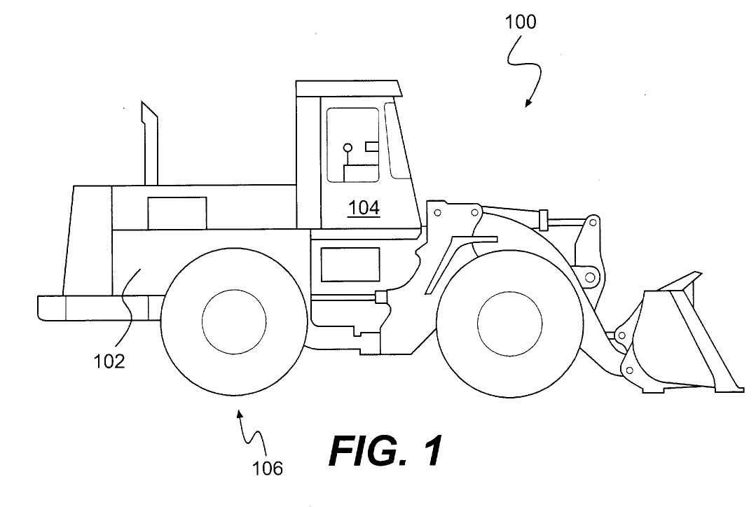

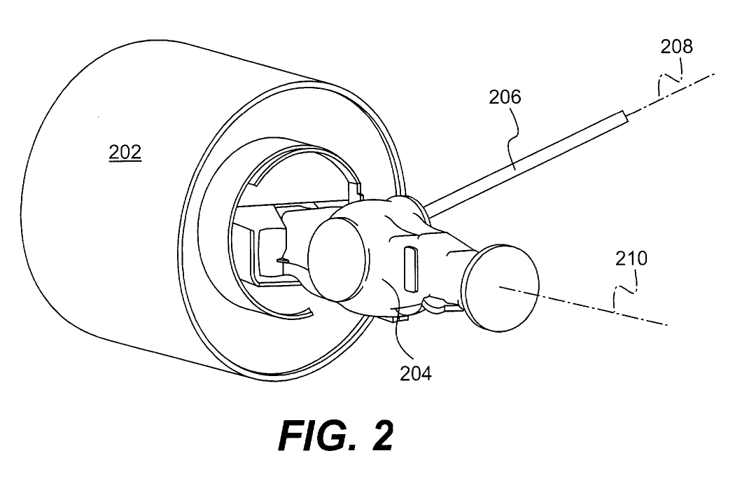

A vehicle 100 is shown in FIG. 1. The vehicle 100 has a machine body 102, an operator compartment 104, and a ground engaging system 106 which provides motive power to the vehicle 100. The ground engaging system 106 is shown in more detail in FIG. 2. The ground engaging system 106 includes at least one wheel 202 attached to an axle housing 204. The axle housing 204 houses the components, mainly gears and a differential, which transform rotation of a driveline 206 along a longitudinal axis 208 into rotation of the wheel 202 about a lateral axis 210.

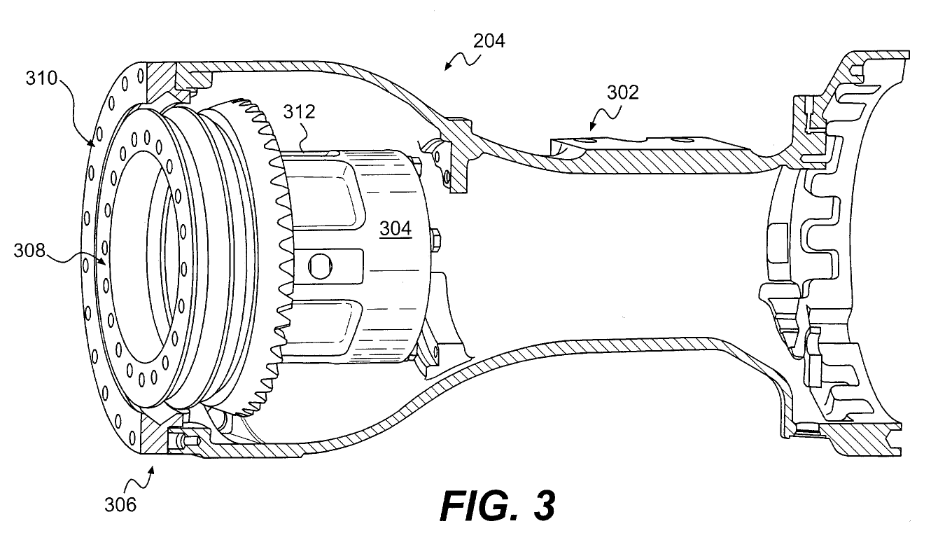

FIG. 3 is a partial perspective cutaway view of a portion of a multi-piece axle housing 204, with the axle normally surrounded by the axle housing 204 omitted here for clarity. The multi-piece axle housing 204 is made up of several subhousings 302 (one shown) which combine to contain the various axle components. The differential is shown at 304. A bearing 306 mounts the differential 304 to the subhousing 302.

The bearing 306 is of particular interest in the present invention, as it substantially supports the differential 304, which must be allowed to rotate relative to the axle housing 204. By “substantially support”, it is meant that no other intermediate structure transfers the weight of the differential to the axle housing 204. The bearing has an inner race 308, which is rotatable with respect to an outer race 310. The inner race 308 is attached to the differential 304. The outer race 310 is attached to at least one of the subhousings 302. Optionally, the differential 304 includes a differential case 312 and the inner race 308 attaches to the differential case 312.

The bearing 306 is shown in FIG. 3 as supporting the differential 304 in a cantilevered manner—that is, holding one end of the differential 304 and suspending the other end in space. However, an embodiment wherein the bearing 306 attaches to the differential 304 in another position or manner, such as about a center portion of the differential 304, will still fall under the claims of the present invention.

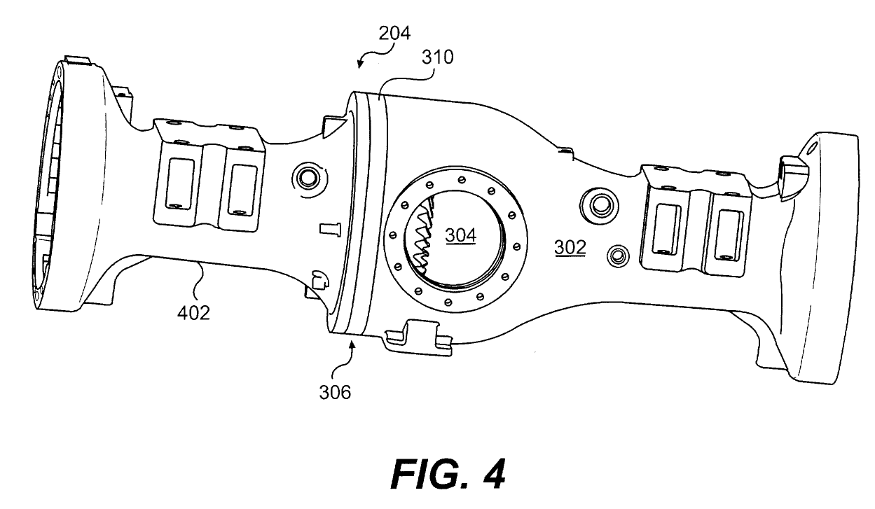

The subhousing 302 may include some sort of inner flange structure to which the bearing 306 is attached in a known manner, the bearing 306 may be formed as a portion of one or more of the subhousings, or the bearing 306 may actually combine with two or more subhousings 302 to form the axle housing 204 as shown in FIG. 4. FIG. 4 depicts a full perspective view of the multi-piece axle housing 204 shown in partial cutaway in FIG. 3. In this case, a first subhousing 302 attaches to the outer race 310 and the outer race 310 attaches to a second subhousing 402. The bearing 306 thereby forms a portion of the axle housing 204. The first and second subhousings 302,402 may be totally separated by the bearing 306 as shown, or they may contact one another. In the embodiment shown in FIG. 4, the first subhousing 302 is commonly known as a long leg housing 302, and the second subhousing 402 is the corresponding short leg housing 402.

### INDUSTRIAL APPLICABILITY

During manufacture, the components of the present invention are readily assembled without requiring that one or more bearings be partially out of view or easy reach of the assembler during the assembly process. In the present invention, the outer race 310 of the bearing 306 is attached to the first subhousing 302. The inner race 308 of the bearing 306 is attached to the differential 304, and any shimming, setting, or other bearing/differential adjustment tasks necessary after the differential 304 is assembled into the first subhousing 302 may be performed. The assembler need only work with one bearing 306, that bearing 306 being easily accessible. Once the bearing 306 is properly placed and adjusted, any temporary intermediate structures between the differential 304 and the first subhousing 302 necessary for assembly are removed and the second subhousing 402 is attached to the first subhousing 302 for completion of the axle housing 204 assembly, making the bearing 306 the only permanent intermediate structure between the differential 304 and the axle housing 204. Preferably, the outer race 310 is located between the first and second subhousings 302,402 to form a portion of the axle housing 204.

The structure of the axle housing 204 and bearing 306 allow for less material and machining needed for the subhousings 302, in that only one set of bearing support structures is provided. This translates into cost savings in building and operating the vehicle 100. Furthermore, a large diameter bearing 306 can absorb and dissipate forces developed during operation of the differential 304 much better than the smaller bearing of the prior art. Since the bearing 306 of the present invention can transmit those forces directly to the axle housing 204 and thereby to the machine body 102, the elaborate bearing mountings (for the smaller bearings) and force transfer structures used previously need no longer be provided within the axle housing 204. This results in manufacturing savings, as well as fewer maintenance and service calls for the ground engaging system 106 and decreased downtime for the work machine 100.

Other aspects, objects and advantages of the present invention can be obtained from a study of the drawings, the disclosure and the appended claims.

What is claimed is:

1. An axle assembly, comprising:
at least two subhousings connectable to form an axle housing;
a differential located inside the axle housing; and
a single bearing mounting the differential to at least one subhousing and substantially supporting the weight of the differential.

2. The axle assembly of claim 1, wherein the bearing has an outer race and an inner race rotatable with respect to the outer race, and the outer race is either attached to the subhousing or a portion of the subhousing, and the inner race is attached to the differential.

3. The axle assembly of claim 2, wherein the differential includes a differential case and the inner race is fixedly attached to the differential case.

4. The axle assembly of claim 1, wherein the at least two subhousings include a long leg housing and a short leg housing, and the bearing connects the differential to the long leg housing.

5. The axle assembly of claim 1, wherein the bearing forms a portion of the axle housing in cooperation with the at least two subhousings.

6. The axle assembly of claim 1, wherein the bearing supports the differential in a cantilevered manner.

7. A method of assembling an axle, comprising:
providing a first subhousing;
attaching an outer race of a single bearing to the first subhousing;
attaching a differential to an inner race of the bearing such that the bearing is the only permanent intermediate structure between the differential and the first subhousing;
surrounding the differential with a second subhousing; and
attaching the second subhousing to the first subhousing.

8. The method of claim 7, wherein the step of attaching the second subhousing to the first subhousing includes:
attaching the second subhousing to the outer race of the bearing.

9. A vehicle, comprising:
a machine body;
an operator compartment carried by the machine body; and
a ground engaging system providing motive power to the machine body, including at least one wheel attached to an axle, the axle including:
at least two subhousings connectable to form an axle housing;
a differential located inside the axle housing; and
a single bearing mounting the differential to the subhousing and substantially supporting the weight of the differential.

10. The vehicle of claim 9, wherein the bearing has an outer race and an inner race rotatable with respect to the outer race, and the outer race is either attached to the subhousing or a portion of the subhousing, and the inner race is fixedly attached to the differential.

11. The vehicle of claim 9, wherein the bearing supports the differential in a cantilevered manner.
